(19) United States
(12) Patent Application Publication
(10) Pub. No.: US 2007/0164516 A1
(43) Pub. Date: Jul. 19, 2007

(54) Seal assembly for vibrating screen

(75) Inventors: Lawrence Calvin Olsen, Springfield, OR (US); Keven Hopkins, Eugene, OR (US); Jon Juhlin, Eugene, OR (US); Trevor Howard, Corvallis, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: JOHNSON CRUSHERS INTERNATIONAL

(21) Appl. No.: 11/333,993

(22) Filed: Jan. 17, 2006

(51) Int. Cl. F16J 15/40

(52) U.S. Cl. 277/347

(57) ABSTRACT

A seal for sealing around a drive shaft protruded through a hole or opening in a liquid containing box. The seal includes a seal housing secured to the box and having a center opening, and a flinger sleeve secured to the drive shaft and projected through the center opening of the seal housing. The sleeve includes an inner wrap-around flange that extends axially inward and radially outward of the center opening to repel liquid directed towards the box hole. A clamping ring provides radial location setting of the seal housing relative to the shaft and axial location setting of the sleeve relative to the seal housing while also providing clamping of the sleeve to the drive shaft.

### FIELD OF INVENTION

This invention relates to a seal construction that prevents/inhibits the leaking of lubricants/oil contained e.g. in a gear box of a vibrating screen e.g. used to separate aggregate into different sizes.

### BACKGROUND OF THE INVENTION

Vibrating screens as contemplated herein are commonly comprised of multiple stacked screen decks. Aggregate (e.g. rocks produced from a rock crusher) is deposited on one end of the top deck and a vibrating motion applied to the screen induces movement of the aggregate along the length of the screen decks. During such movement smaller rock is dropped through the top screen deck to an underlying deck and then to a further underlying deck. The rock is vibrated off the opposite deck ends and conveyed to storage areas for disbursement into e.g. storage piles by size.

The vibration applied to the screen decks is produced by multiple rotating gears having off-set weights. The gears and weight locations are synchronized to produce the desired vibration.

It is desirable to continuously cool the rotating gears and this is accomplished by providing an enclosure for the gears and placing a quantity of oil in the bottom of the enclosure (sometimes here after referred to as the gear box). As the gears are rotated, the gears and/or the gear weights, engage or dip into the oil at a high rate of speed which flings/throws the oil throughout the enclosure to achieve lubrication.

The gears are driven by a drive shaft that extends from outside the box and into the box. The drive shaft rotates and the point of penetration of the drive shaft through the box (or box cover) presents a point of potential oil leakage. Such leakage is protected by a seal assembly surrounding the hole and which is intended to prevent leakage through the hole.

A type of seal assembly used heretofore includes closely spaced seal rings (on opposing surfaces of the surrounding hole and drive shaft) and a labyrinth construction that inhibited oil passage between the rings. To be effective the seals are in close relation axially. The operation of a vibrating screen mandates some relative movement (radial run out) which will not accommodate such close spacing and the resulting contact (i.e. rubbing together of the seal rings), produces rapid wearing of the sealing elements and then leaking of the oil.

### BRIEF DESCRIPTION OF THE INVENTION

The present invention takes into consideration several characteristics of the gear box configuration. With the gears at rest (i.e. non-operating), the oil is contained in the bottom of the box and is below the position of the shaft and it is only the oil that is flung about the enclosure that produces the leaking problem. Upon stopping of the gear rotation, the oil drains back down into the bottom of the box. At rest (non-operating) and after draining, there is no oil in the vicinity of the shaft penetration. The present invention accordingly produces a seal against such oil leakage but without the undesired rubbing contact as explained above.

In a preferred embodiment, this is accomplished by a three piece assembly. A first piece is referred to as a seal housing defining a hole or opening and is bolted to a cover portion of the box and the hole in the housing aligned with the hole in the cover. Such permits projection of the shaft into the box. A second piece is referred to as a flinger sleeve and primarily resides inside the seal housing and inside the gear box. The third piece is referred to as a clamping ring that resides outside the seal housing and outside the gear box. The sleeve and clamping ring are secured to each other and to the shaft. The sleeve and clamping ring are cooperatively configured relative to the seal housing to provide sufficient spacing to avoid rubbing engagement as between the housing and the combined sleeve and ring but have interfitting (non-contacting) features that inhibit/prevent oil from penetrating through the housing and thus through the hole in the cover of the gear box.

A particular characteristic of the interfit is an inner wrap around flange of the rotating sleeve that repels the oil spray. A further characteristic is an angled channel formed between the flange and the housing culminating in a trough formed between the sleeve and seal housing. Oil that may get past the flange and into the channel is centrifugally urged back into the cavity of the box during operation. On operational shut down, when oil drains back into the oil bath, any oil that collects in the trough flows around the shaft and back into the cavity.

A further feature of the clamping ring performs the task of centering the shaft, sleeve and clamping ring in the hole of the seal housing to create a desired spacing that will accommodate the relative movement of the shaft and gear box. This latter feature and a further understanding of the non-contact seal configuration will be more clearly understood and appreciated upon reference to the following detailed description of the preferred embodiment (s) having reference to the accompanying drawings.

### DESCRIPTION OF DRAWING

FIG. 1 is a schematic top view of an aggregate screen that may incorporate the features of the present invention;

FIG. 2 is a cross sectional view of the drive shaft and gear box as taken on view lines 2-2 of FIG. 1;

FIG. 3 is a perspective view of a seal housing as incorporated into a screen seal in accordance with the invention;

FIG. 4 is a cross sectional view as seen from view line 4-4 of FIG. 3;

FIG. 5 is a perspective view of a clamping ring as incorporated into the seal housing of FIG. 3;

FIG. 6 is a cross sectional view as seen from view line 6-6 of FIG. 5;

FIG. 7 is a perspective view of a flinger sleeve as incorporated into the housing and ring of FIGS. 3 and 5;

FIG. 8 is a cross sectional view as seen from view line 8-8 of FIG. 7;

FIG. 9 is a cross sectional view of the components of FIGS. 3-8 in assembled arrangement;

FIG. 10 is an enlarged view intended to illustrate the operational affect of the assembly of FIG. 9; and

FIG. 11 is a view of the components of FIGS. 3-8 and similar to FIG. 10 but illustrating the use of the clamping ring as an aid for relative centering of the components.

### DETAILED DESCRIPTION OF PREFERRED EMBODIMENT(S)

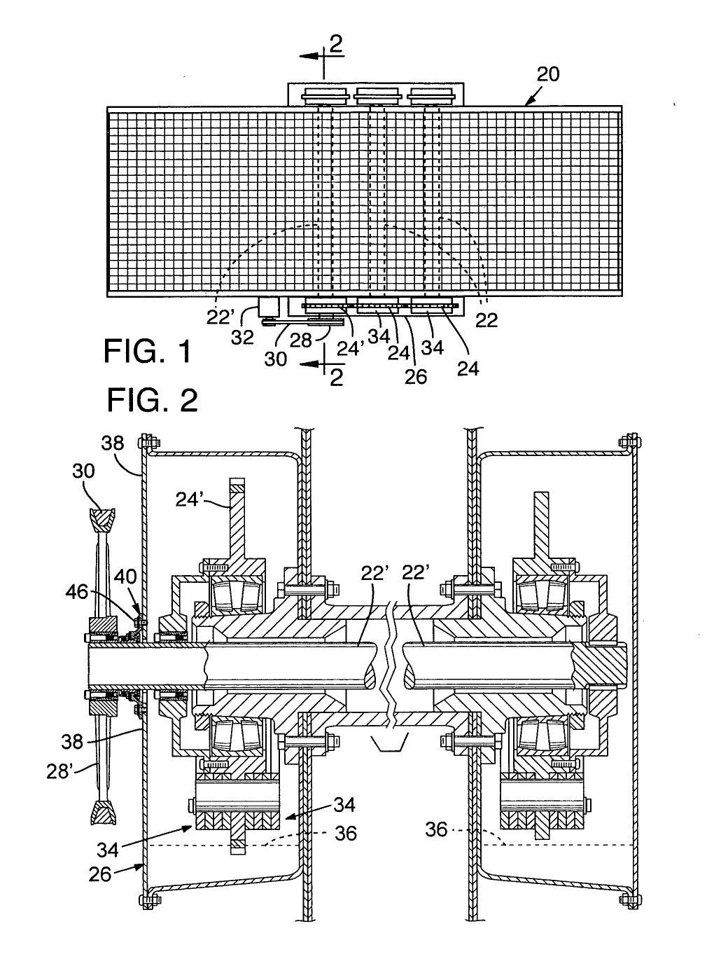

Reference is first made to FIG. 1, which schematically illustrates an aggregate separating screen 20 as may be used to separate aggregate e.g. as produced in a rock crushing process, the screen likely having multiple screen decks with differently sized screen openings. The frame supporting the screen decks is mounted on rotatable shafts 22. As illustrated in FIG. 1, each shaft 22 is provided with intermeshing gears 24 (at the lower side of the drawing) which is encased in a gear box 26. One shaft 22′ extends through its gear 24′ and through the wall of the gear box (which may be a removable cover portion of the gear box). The protruded portion of the shaft 22′ is fitted with a drive sheave 28. A belt or chain 30 extends from the sheave to a drive motor 32. The motor drives the shaft 22′ as well as the other shafts 22 via gears 24.

Briefly and with reference to FIG. 2, the arrangement of the shaft 22′ and gear box 26 as explained in the previous paragraph is shown in more detail. Shaft 22′ extends through a cover portion 38 of gear box 26. Weights 34 are strategically mounted to gears 24 and as the shafts 22 are rotated, the offset weight of weights 34 produce a desired vibration to the screen decks of the screen 20 and produces a desired advancement of aggregate placed on the receiving end of the screen for shuffling the aggregate towards the opposite or discharge end. This process and the apparatus for producing the process are well known to those skilled in the art and will not be further explained. Reference is made to the commonly owned U.S. Pat. No. 6,386,375 and its disclosure which is incorporated herein by reference.

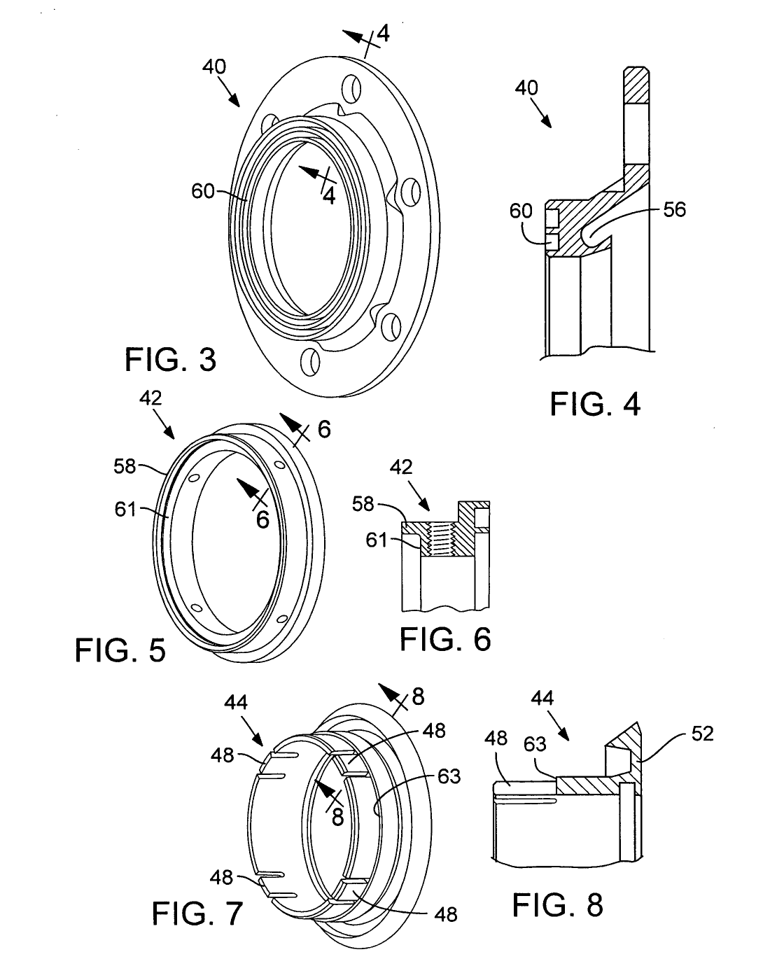

Again referring to FIG. 2 and as previously described, the gears contained in the gear box are preferably lubricated. This is accomplished by placement of a quantity of liquid lubricant e.g. oil in a bottom portion of the gear box as indicated by dash line 36. In operation, the gears 24 and weights 34 impact the oil 36 during rotation of the gears 24 and oil is flung about the cavity of the gear box. The oil is splattered or sprayed in a random pattern and all exposed surface areas within the cavity of the gear box including the area whereat the shaft 22′ protrudes through the cover portion 38 of the gear box 26. The avoidance of oil leakage from the gear box through the opening provided for shaft protrusion is an object of the invention and such avoidance is now explained with reference to FIGS. 3-10.

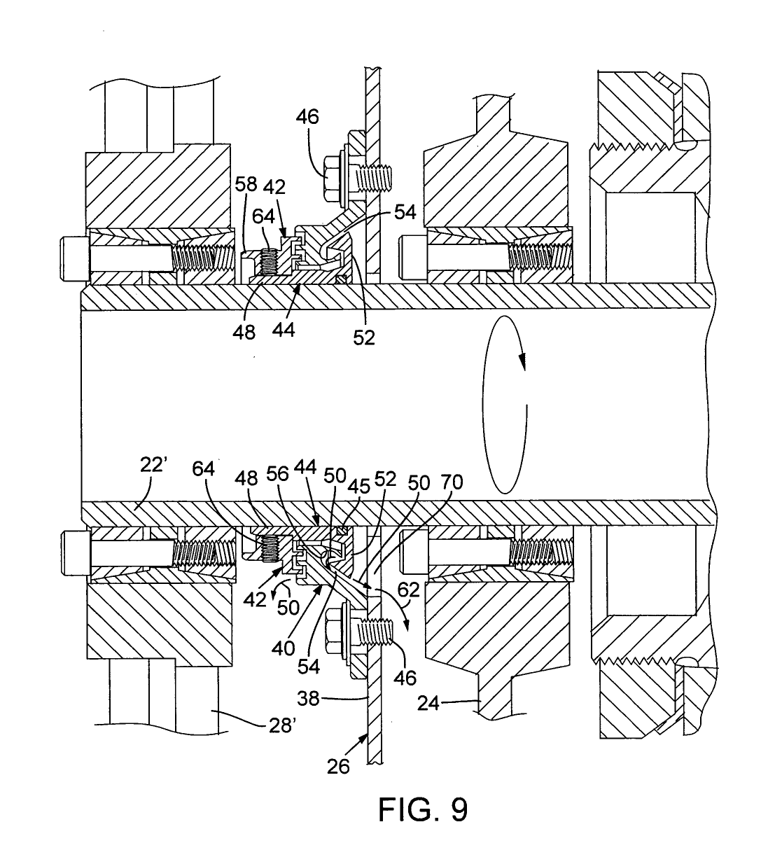

The seal assembly of the illustrated embodiment is comprised of three parts referred to as the seal housing 40 (see FIGS. 3 and 4) the clamping ring 42 (see FIGS. 5 and 6) and flinger sleeve 44 (see FIGS. 7 and 8). These components as assembled to the gear box 26 are shown in cross section in FIG. 9. With reference particularly to FIG. 9 it will be appreciated that the gear box 26 is non-rotative and the shafts 22 (and gears 24) are rotating during the screening operation.

From FIG. 9 it will be further appreciated that seal housing 40 of the screen seal is secured to the gear box 26 (specifically the cover portion 38) via bolts 46. Flinger sleeve 44 and clamping ring 42 are secured to drive shaft 22′. This latter securement is provided by set screws 64 which protrude through ring 42 and engage fingers 48 of the sleeve 44 (see FIG. 7) and fingers 48 are thereby urged into clamping relation with the shaft 22′. An O ring 45 assures sealing as between the sleeve 44 and shaft 22′ which are rotating in unison.

Accordingly, from FIG. 9, the clamping ring 42 and flinger sleeve 44 rotate relative to seal housing 40 but such relative rotation occurs without contact between the components as enabled by the creation of an ample tortuous space or pathway denoted by arrows 50. A wrap around rotating flange 52 of sleeve 44 provides a barrier that repels any oil coming into contact with it. An angled channel 54 forming a portion of the pathway 50 culminates in a groove or trough 56 formed in the housing 40 (see also FIG. 4).

Whereas the non-contact configuration of the components substantially prevents oil leakage during operation, upon stopping the operation and thus the rotation of the gears and drive shaft, oil that may be captured in the trough 56 will simply drain down around the shaft into the bottom side of the shaft where it will flow downwardly and inwardly along angled channel 54 of pathway 50 (see arrow 62 at bottom of FIG. 9).

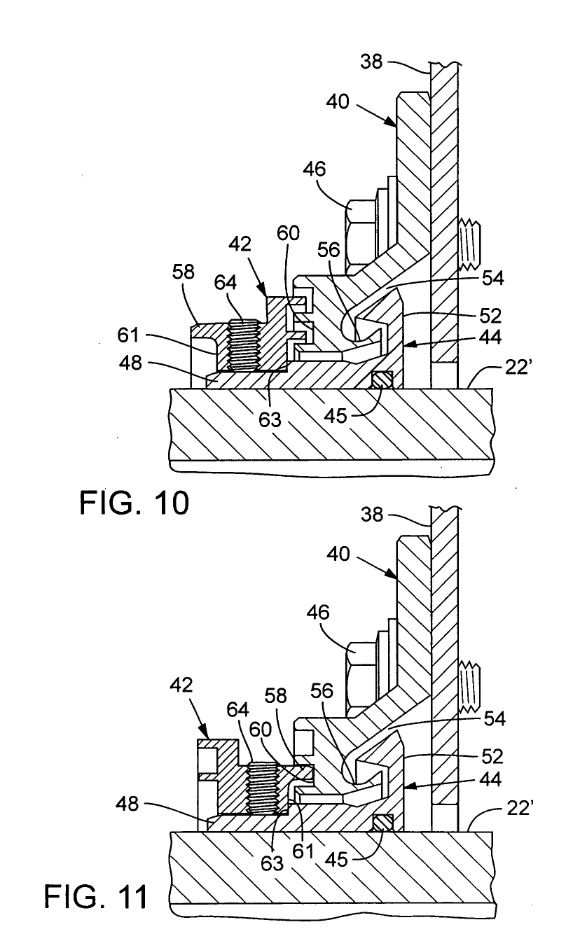

The operational effect of the seal configuration described above will be further appreciated with reference to the enlarged cross sectional view of FIG. 10. It will be further appreciated that the optimal relationship of the seal components as described relies on substantially precise rotative positioning both axially and radially as between the seal housing 40 and the ring 42/sleeve 44. In particular, the seal housing should be precisely secured in a centered relationship relative to the flinger sleeve. This desired precision is provided in the preferred embodiment by the provision of a positioning rib 58 provided on the opposing end of the clamping ring. Reference is made to FIG. 11 which shows the clamping ring 42 reversed from that position shown in FIG. 10. Prior to centering as shown in FIG. 11, the sleeve 44 is pulled outward e.g. into engagement with the housing 40. With the ring 42 so mounted on the shaft, a rib 58 of ring 42 is inserted into the groove 60 of the seal housing and as such engages both the upper face and inner face defined by the groove 60 as illustrated. Further, edge 61 of the ring 42 engages edge 63 of the sleeve 44 and moves the sleeve 44 to the desired axial position. Such insertion precisely radially positions the seal housing 40. Upon locked engagement of the housing 40 to the cover 38 via bolts 46, the ring 42 is reversed and set screws 64 tightened to secure axial positioning of sleeve 44 and thus the desired creation of path way 50.

As will be appreciated from FIG. 9, the cover 38 surrounding the shaft 22′ is notched (notch 70) at the bottom of the hole for enlargement thereof to enable draining of oil as indicated by arrow 62.

The above description is of a preferred embodiment of the invention and is subject to various revisions, modifications, and alterations without departing from the essence of the invention. As an example, it is anticipated that whereas it is deemed preferable to avoid any rubbing contact as enabled by the above radial and axial spacing between the housing and assembled clamping ring and flinger sleeve, an alternate design may incorporate additional sealing structure to augment the seal affect of this invention. Accordingly the claims appended hereto are intended to be broadly interpreted in accordance with the common meaning of the terms used in the claims to define the invention.

1. A seal assembly for sealing around a rotatable drive shaft extended through a hole in a gear box, said gear box defining an interior wherein liquid lubricant is sprayed around the gear box interior, said seal assembly comprising:
a seal mount and a flinger sleeve, said seal mount mountable to said gear box and as mounted defining an opening surrounding said shaft extended through said hole;
said flinger sleeve mountable to said shaft and as mounted protruded through said opening of said seal mount and in desired spaced radial and axial relation to said seal mount; and
said seal mount and flinger sleeve cooperatively configured as so mounted with the sleeve including an inner wrap-around flange rotatable with rotation of said shaft and which wraps axially inward and radially outward of said opening of said seal mount whereby lubricant directed towards said seal mount opening is repelled away from the opening upon contact with said rotating flange.

2. A seal assembly as defined in claim 1 wherein said flange defines an angled radially out board edge, and said seal mount including a circular trough and an outwardly angled surface from said trough, said out board edge of said flange and said angled surface of said seal mount cooperatively defining a channel for directing liquid lubricant from said trough back into said gear box interior.

3. A seal assembly as defined in claim 1 wherein the flinger sleeve includes a sleeve portion that extends axially outward of said surrounding seal mount and a clamping ring clamping said sleeve to the shaft.

4. A seal assembly as defined in claim 2 wherein the spacing as between the seal housing and flinger sleeve defines a tortuous path including said channel that inhibits leakage of the liquid lubricant.

5. A seal assembly as defined in claim 1 including a spacer member that fits onto one of said drive shaft and flinger sleeve and includes a circular spacer rib, said seal mount including a circular lip mateable to said rib, said spacer member as fitted to said one of said drive shaft and flinger sleeve is insertable in said spacer rib for radial centering of said seal mount whereby securing said seal mount to said gear box properly centers the seal mount relative to said drive shaft.

6. A seal assembly as defined in claim 1 including a spacer member that circumferentially fits onto one of said drive shaft and flinger sleeve and as so fitted abuts said seal mount, said spacer member further including a circular spacer edge that abuts the flinger sleeve and desirably axially locates said flinger sleeve relative to said seal mount for clamping and securing of said sleeve.

7. A seal assembly as defined in claim 5 wherein said spacer member as fitted to said circular lip axially abuts said seal mount, and said spacer member and said flinger sleeve including further abutting edges and in said further abutment, desirably locating said flinger sleeve axially relative to said seal mount.

8. A seal assembly as defined in claim 7 wherein said spacer member further includes clamping securement of said sleeve to said shaft.

9. A seal assembly for sealing an opening through an opening in a wall of a gear box, said opening providing protrusion of a drive shaft as between an interior and exterior of the gear box and wherein liquid lubricant is sprayed throughout the interior and is desirably prevented from leaking through said opening, said seal assembly comprising:
a seal housing, a flinger sleeve and a clamping ring;
said seal housing mountable to a wall of the gear box and defining an opening surrounding the drive shaft protruded through said gear box opening;
said flinger sleeve mountable to said drive shaft and as mounted, protruded through said opening of said housing, said flinger sleeve configured to have an inner flange extended axially inwardly and radially outwardly of said opening of the seal housing;
said clamping ring and said seal housing cooperatively configured to have mateable rib and lip components and said clamping ring and said flinger sleeve cooperatively configured to have mateable abutting edges whereby with the clamping ring mounted to the drive shaft and the rib and lip component mated, the seal mount can be desirably located for securement to the gear box, and as secured with the edges of the ring and sleeve in abutment, the sleeve can be secured to said shaft for desirable spacing of the flange axially relative to the seal mount.

10. A seal assembly as defined in claim 9 wherein the clamping ring includes a clamping feature for clamping the flinger sleeve to the drive shaft.

11. A seal assembly as defined in claim 10 wherein said clamping ring is reversible and clamping screws are provided on the ring axially opposite the edge and rib thereof and following desired location of the seal mount and flinger sleeve is reversible on the shaft for clamping the sleeve to the shaft.

12. A seal assembly as defined in claim 11 wherein the sleeve is provided with bendable tab and with ring screw positioned over the tabs and screwed down against the tabs, the tabs are clamped to the drive shaft.
